(19) United States
(12) Patent Application Publication
(10) Pub. No.: US 2026/0147502 A1
(43) Pub. Date: May 28, 2026

(54) METHOD OF TESTING MEMORY DEVICE

(71) Applicant: SK hynix Inc., Icheon-si Gyeonggi-do (KR)

(72) Inventors: Hyeong Seon PYO, Icheon-si Gyeonggi-do (KR); Yi Hun KIM, Icheon-si Gyeonggi-do (KR)

(73) Assignee: SK hynix Inc., Icheon-si Gyeonggi-do (KR)

(21) Appl. No.: 19/402,458

(22) Filed: Nov. 26, 2025

(30) Foreign Application Priority Data
Nov. 28, 2024 (KR) 10-2024-0173727

(51) Int. Cl. G06F 3/06

(52) U.S. Cl. CPC G06F 3/0653; G06F 3/0604; G06F 3/0679

(57) ABSTRACT

A method of testing a memory device includes testing for a physical defect of memory devices formed on a wafer, determining a region of the wafer where the memory devices are located when a test result for the physical defect is a pass, inputting first operation conditions to memory devices located in a first region and inputting second operation conditions to memory devices located in a second region, and simultaneously testing the memory devices input with the first operation conditions and the memory devices input with the second conditions under various conditions.

### CROSS REFERENCE TO RELATED APPLICATION

The present application claims priority under 35 U.S.C. §119(a) to Korean patent application number 10-2024-0173727 filed on November 28, 2024, in the Korean Intellectual Property Office, the entirety of which application is incorporated herein by reference.

### BACKGROUND

### 1. Technical Field

The present disclosure relates to a method of testing a memory device, including but not limited to a method of testing and classifying a memory device.

### 2. Related Art

During semiconductor manufacturing processes, a plurality of dies are formed on a wafer. Each of the plurality of dies are processed into a memory device including a memory block and peripheral circuits.

Because the plurality of dies formed on the same wafer are manufactured simultaneously, the dies formed across all areas of the wafer do not have identical electrical characteristics due to the physical characteristics and variance of manufacturing processes. Because the semiconductor manufacturing processes are primarily centered on a central region of the wafer, the reliability of dies located in the central region may be higher than the reliability of dies located in peripheral or outer regions of the wafer. Reliability may include to physical and/or electrical defects. For example, a physical defect includes elements that contact each other but should be spaced apart and elements differing in size from a target size. Various other physical defects may occur. An electrical defect includes an operation speed slower than a target speed or errors occurring during a program operation, a read operation, or an erase operation. Various other electrical defects may occur. Higher die reliability correlates with fewer physical and electrical defects, while lower reliability correlates with more physical and electrical defects.

### SUMMARY

According to an embodiment, a method of testing a memory device may include testing for a physical defect of memory devices formed on a wafer, determining a region of the wafer where the memory devices are located when a test result for the physical defect is a pass, inputting first operation conditions to memory devices located in a first region and inputting second operation conditions to memory devices located in a second region, simultaneously testing the memory devices input with the first operation conditions and the memory devices input with the second conditions under various conditions.

According to an embodiment, a method of testing a memory device may include manufacturing a plurality of memory devices on a wafer, identifying a set of the plurality of memory devices as first memory devices located within a first distance from a center point of the wafer and a set of the plurality of memory devices as second memory devices located between the first distance and a second distance farther than the first distance from the center point, inputting first driving conditions for program operations, read operations, and erase operations into the first memory devices and inputting second driving conditions corresponding to lower reliability than the first driving conditions into the second memory devices, and simultaneously testing the first memory devices and second memory devices under various conditions.

### BRIEF DESCRIPTION OF THE DRAWINGS

FIG. 1 is a diagram illustrating a wafer according to an embodiment of the present disclosure;

FIG. 2 is a diagram illustrating memory devices formed on a wafer according to an embodiment of the present disclosure;

FIG. 3 is a diagram illustrating a first memory device according to an embodiment of the present disclosure;

FIG. 4 is a flowchart illustrating a method of testing a memory device according to an embodiment of the present disclosure;

FIG. 5 is a diagram illustrating driving conditions input to a memory device according to an embodiment of the present disclosure;

FIG. 6 is a diagram illustrating a region of a wafer according to an embodiment of the present disclosure; and

FIG. 7 is a flowchart illustrating a method of testing a memory device according to an embodiment of the present disclosure.

### DETAILED DESCRIPTION

Embodiments of the present disclosure are described in detail with reference to the accompanying drawings. Specific structural or functional descriptions of embodiments are provided as examples to describe concepts that are disclosed in the present application. Examples or embodiments in accordance with the concepts may be carried out in various forms, and the scope of the present disclosure is not limited to the examples or embodiments described in this specification.

Terms such as “first” and “second” are used to distinguish between various elements and do not imply size, order, priority, quantity, or importance of the elements. For example, a first element may be referred to as a second element in one example, and the second element may be referred to as a first element in another example.

The cross-hatching throughout the figures illustrates corresponding or similar areas between the figures rather than indicating the materials associated with the areas. The drawings are not necessarily drawn to scale.

Memory devices used in electronic devices may have varying levels of reliability depending on the application of the electronic device. When wafers are tested differently based on electronic device product group, memory devices unsuitable for the corresponding product group may be discarded, which reduces yield. For example, when two wafers are designated for different product groups, a first wafer is tested according to a high-specification product group, and the second wafer is tested according to a low-specification product group. Testing memory devices on a single wafer using the same criteria may reduce yield and testing each wafer separately for different product groups may increase the time utilized for test operations. The present disclosure describes a method of testing memory devices including simultaneous testing of memory devices having different reliability levels depending on a region of a wafer and subsequent shipment based on testing results.

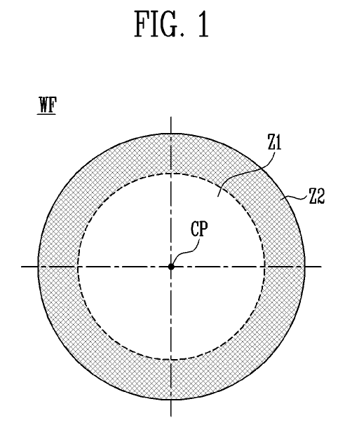

FIG. 1 is a diagram illustrating a wafer WF.

Referring to FIG. 1, the wafer WF is a substrate upon which dies are formed. The wafer WF may be a circular substrate obtained by cutting a monocrystalline silicon ingot, grown from silicon (Si) or gallium arsenide (GaAs), into thin slices. A plurality of dies are formed on the wafer WF and each of the plurality of dies may be manufactured using semiconductor manufacturing processes into a memory chip capable of storing data.

The process of manufacturing dies on the wafer WF is performed in various chambers of manufacturing equipment. Due to the physical characteristics and variance of manufacturing equipment, the physical and electrical properties of the dies vary depending on the region of the wafer WF where the dies are located. For example, the wafer WF may include a first region Z1 and a second region Z2 identified based on the distance from a center point CP of the wafer WF. The first region Z1 is the central region closer to the center point CP of the wafer WF than the second region Z2, and the second region Z2 is a peripheral or outer region farther from the center point CP of the wafer WF than the first region Z1. The second region Z2 surrounds the periphery of the first region Z1.

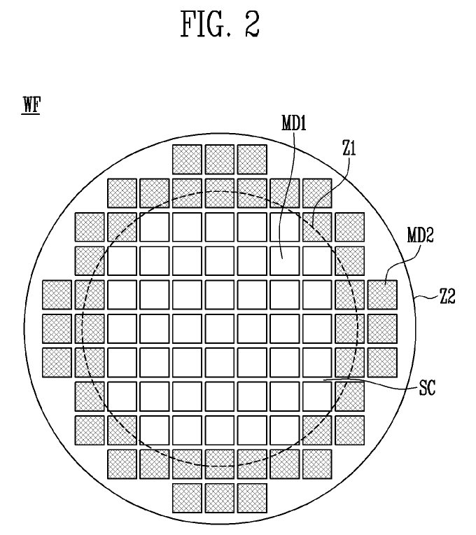

FIG. 2 is a diagram illustrating memory devices formed on the wafer WF.

Referring to FIG. 2, a plurality of memory devices MD1 and MD2 are formed on the wafer WF. The memory devices MD1 and MD2 may be referred to as dies. Among the plurality of memory devices MD1 and MD2, each of a set of memory devices located in the first region Z1 is a first memory device MD1, and each of a set of memory device located in the second region Z2 is a second memory device MD2. When a memory device is located at the boundary between the first region Z1 and the second region Z2, the memory device is a second memory device MD2. The criteria for distinguishing between the first memory devices MD1 and the second memory devices MD2 may vary depending on the wafer WF.

The memory devices MD1 and MD2 are spaced apart from by a scribe lane SC. After the memory devices MD1 and MD2 are formed on the wafer WF, and the memory devices MD1 and MD2 are separated by cutting along the scribe lane SC for packaging.

The memory devices MD1 and MD2 may be used in electronic devices of various different product groups. For example, the memory devices MD1 and MD2 manufactured on the same wafer WF may be manufactured as the same type of memory device. For example, the memory devices MD1 and MD2 may be manufactured as volatile memory devices, where stored data is lost when power is cut off or no longer supplied, or as non-volatile memory devices, where stored data is retained when power is cut off or no longer supplied. The volatile memory device may be random access memory (RAM), and the RAM may be classified as dynamic random access memory (DRAM) or static random access memory (SRAM). Non-volatile memory devices include NAND flash memory, NOR flash memory, resistive random access memory (ReRAM), phase-change memory (PRAM), magneto-resistive random access memory (MRAM), ferroelectric random access memory (FRAM), or spin transfer torque random access memory (STT-RAM). In an embodiment, the memory devices MD1 and MD2 are non-volatile memory devices.

The first memory devices MD1 are located in the first region Z1, and the second memory devices MD2 are located in the second region Z2. The reliability of the first memory devices MD1 is typically higher than the reliability of the second memory devices MD2. Therefore, the first memory devices MD1 may be used in high-specification products exceeding the baseline specifications, while the second memory devices MD2 may be used in low-specification products below the baseline specifications.

The memory devices MD1 and MD2 are formed simultaneously on the same wafer WF and are configured identically. The detailed structure of the memory devices MD1 and MD2 is described.

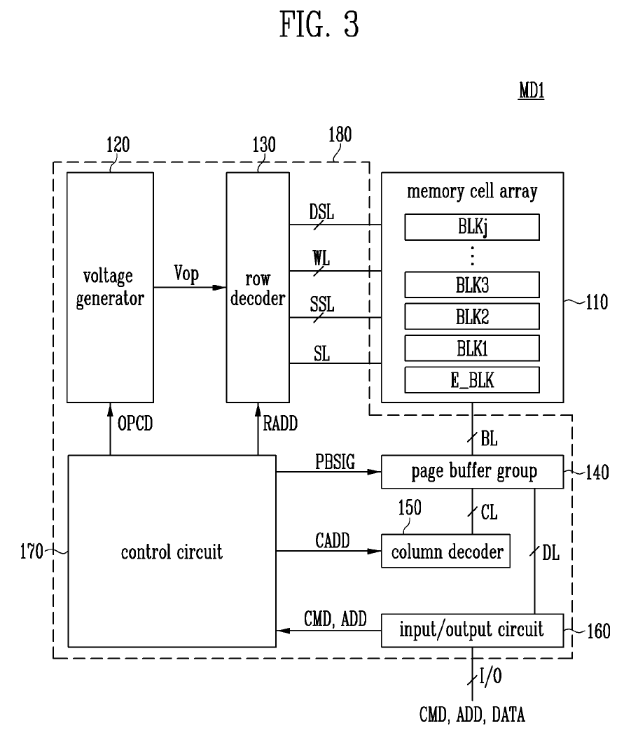

FIG. 3 is a diagram illustrating the first memory device MD1.

Referring to FIG. 3, the memory devices MD1 and MD2 include a memory cell array 110 where data is stored and peripheral circuits 180 configured to perform program operations, read operations, and erase operations.

The memory cell array 110 includes a first memory block BLK1 to a j-th memory blocks BLK1 to BLKj where normal data is stored and an extra block E_BLK where system data is stored, where j is an integer. Normal data includes user data that is input or output during a normal program operation and a normal read operation. System data is used by the memory devices MD1 and MD2 and includes condition values for performing normal program operations, read operations, and erase operations. The system data includes unique information about the first memory device MD1 or the second memory device MD2. The extra block E_BLK may be a spare block, a content addressable memory (CAM) block, or a one-time programmable (OTP) block.

Each of the memory blocks BLK1 to BLKj and the extra block E_BLK includes memory cells. The memory cells may be implemented with a 2D structure arranged parallel to the substrate or with a 3D structure stacked perpendicular to the substrate.

The peripheral circuits 180 include a row decoder 130, a voltage generator 120, a page buffer group 140, a column decoder 150, an input/output circuit 160, and a control circuit 170.

The row decoder 130 selects one memory block from among the memory blocks included in the memory cell array 110 based on a row address RADD and transfers operating voltages Vop to the selected memory block.

The voltage generator 120 generates and outputs operating voltages Vop utilized during various operations in response to an operating code OPCD. For example, the voltage generator 120 generates and selectively output voltages such as a program voltage, a read voltage, an erase voltage, a pass voltage, and a turn-on voltage in response to the operating code OPCD.

The page buffer group 140 is coupled to the memory cell array 110 via bit lines. For example, the page buffer group 140 includes a different page buffer coupled to each of the bit lines. The page buffers may operate simultaneously in response to page buffer control signals PBSIG and temporarily store data during program operations, read operations, or verify operations. During a read or verify operation, the page buffers sense current in the bit lines, which current varies according to threshold voltages of the memory cells.

The column decoder 150 transfers data DATA between the input/output circuit 160 and the page buffer group 140 based on a column address CADD.

The input/output circuit 160 is coupled to an external device via input/output lines I/O. For example, the external device may be a controller capable of transferring a command CMD, an address ADD, and the data DATA to the memory devices MD1 or MD2. The input/output circuit 160 inputs/outputs the command CMD, the address ADD, and the data DATA via input/output lines I/O. For example, the input/output circuit 160 transfers the command CMD and the address ADD received from an external device via the input/output lines I/O to the control circuit 170 and transfers the data DATA received from the external device via the input/output lines I/O to the page buffer group 140. The input/output circuit 160 outputs the data DATA received from the page buffer group 140 to an external device via the input/output lines I/O.

The control circuit 170 outputs the operating code OPCD, the row address RADD, the page buffer control signals PBSIG, and the column address CADD in response to the command CMD and the address ADD. For example, the control circuit 170 includes software that performs an algorithm in response to the command CMD and hardware configured to output the address ADD and various control signals.

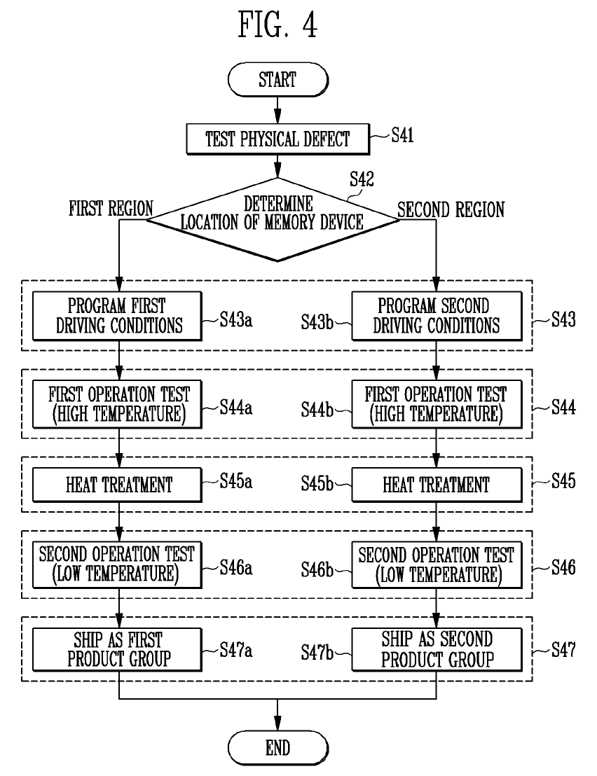

FIG. 4 is a flowchart illustrating a method of testing a memory device according to an embodiment of the present disclosure. The processes of the flowchart may be performed in a different order and may include fewer or additional processes than described and shown in FIG. 4. The flowchart of FIG. 4 may be performed by equipment that manufactures the memory device or separate test equipment configured to evaluate/program memory devices for various properties such as physical defects and performance characteristics.

Referring to FIG. 4, after manufacturing processes for the memory devices are completed, a physical defect test is performed S41 on memory devices formed on the same wafer. Physical defects within a memory device include elements that contact each other but should be spaced apart or elements that should be in contact or extended but are spaced apart. Because physical defects significantly impact the reliability of memory devices, memory devices with a fail result from the physical defect test are classified separately from memory devices with a pass result. The memory devices classified as failed are difficult to use as memory devices and may be discarded.

Upon completion of the physical defect test, the locations are determined S42 for the memory devices that passed the physical defect test S41. For example, as described with reference to FIG. 2, the memory devices located in the first region Z1 of the wafer are distinguished S42 from the memory devices located in the second region Z2 of the wafer. In an embodiment, the memory devices located in the first region Z1 have higher reliability than the memory devices located in the second region Z2.

After the locations of the memory devices are determined S42, driving conditions for each memory device are programmed S43 based on the determined locations. The driving conditions may include unique information for a memory device and various values that enable normal operations, such as program operations, read operations, and erase operations, to be performed on the memory device. The unique information for the memory device may include storage capacity information, normal operation condition information, and manufacturing date information. The driving conditions are programmed into the extra block E_BLK in FIG. 3 included in each memory device MD1 or MD2. First driving conditions are programmed S43a into the memory devices located in the first region, and second driving conditions, different from the first driving conditions, are programmed S43b into the memory devices located in the second region. For example, the first driving conditions correspond to values for product groups utilizing higher reliability than the second driving conditions. The product group may be a type of electronic device in which a memory device is included. The first driving conditions may programmed S43a at the same time the second driving conditions are programmed S43b.

Upon completion of the programming S43, a first operation test is performed S44 to determine whether normal operations performed by the memory devices may be performed correctly at a higher temperature than a reference temperature. In an embodiment, during the first operation test S44, a test program operation, a test read operation, and a test erase operation are performed. For example, the test program operation may be performed by programming test data into the memory device and measuring the time taken for the test program operation. For example, the test read operation may be performed by measuring the time taken to read the test data programmed during the test program operation. For example, the test erase operation may be performed by measuring the time utilized to erase the memory block into which the test data is programmed. During the first operation test S44, various parameters may be tested in addition to the time taken for the test program operation, the test read operation, and the test erase operation. The pass criteria for the first operation test S44 may differ depending on the location of the memory devices. For example, when the pass criterion for the first operation test performed S44a on the memory devices located in the first region is a first time, the pass criterion for the first operation test performed S44b on the memory devices located in the second region is a second time that is slower than the first time.

Upon completion of the first operation test S44, heat treatment is performed S45 on the wafer. The heat treatment may be performed S45a, S45b at temperatures between 100 °C and 200 °C for durations between 30 minutes and 90 minutes, although the heat treatment conditions are not limited to these examples.

Upon completion of heat treatment S45, a second operation test is performed S46 to determine whether normal operations performed in the memory devices may be performed correctly at a lower temperature than the reference temperature. The second operation test may be performed S46 in the same manner as the first operation test S44. For example, during the second operation test S46, a test program operation, a test read operation, and a test erase operation are performed. For example, the test program operation may be performed by programming test data into the memory device and measuring the time taken for the test program operation. For example, the test read operation may be performed by measuring the time taken to read the test data programmed during the test program operation. For example, the test erase operation may be performed by measuring the time taken to erase the memory block into which the test data is programmed. In addition to the time taken for the test program operation, the test read operation, and the test erase operation, various other parameters may be tested during the second operation test S46. The pass criteria for the second operation test S46 may differ depending on the location of the memory devices. For example, when the pass criterion for the second operation test performed S46a on the memory devices located in the first region is a third time, the pass criterion for the second operation test performed S46b on the memory devices located in the second region is a fourth time that is slower than the third time.

After completion of the second operation test S46, memory devices that passed all tests ship S47 as a product group corresponding to the respective performance levels. For example, the memory devices located in the first region that passed all tests S41, S44a, and S46a ship S47a as a first product group. The memory devices located in the second region that passed all tests S41, S44b, and S46b ship S47b as a second product group. The first product group is a group of electronic devices utilizing higher reliability than the second product group.

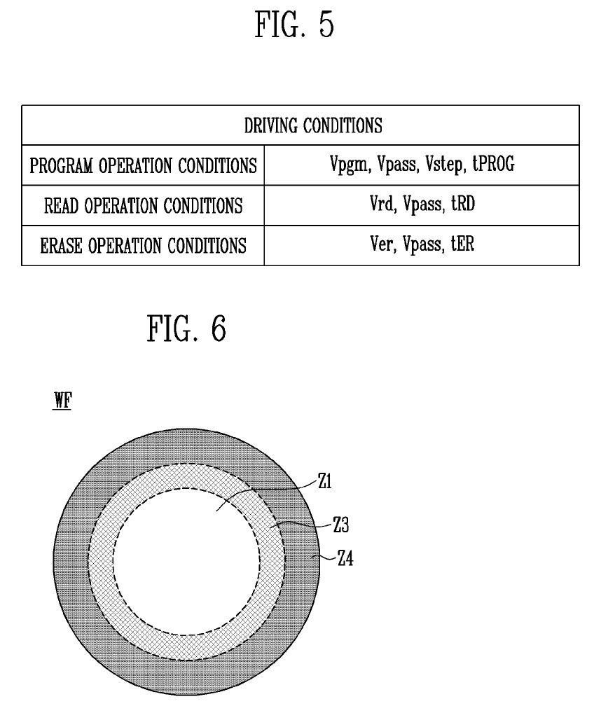

FIG. 5 is a diagram illustrating driving conditions input to memory devices.

Referring to FIG. 5 and FIG. 4, the driving conditions programmed S43 into each memory device differ depending on operation type, such as program operations, read operations, and erase operations. For example, program operation conditions include program voltage Vpgm, pass voltage Vpass, step voltage Vstep, and program operation time tPROG. The read operation conditions include read voltage Vrd, pass voltage Vpass, and read operation time tRD. The erase operation conditions include erase voltage Ver, pass voltage Vpass, and erase operation time tER. Additional conditions utilized to perform a program operation, a read operation, and an erase operation may be included in the driving conditions.

FIG. 6 is a diagram illustrating regions of a wafer according to a second embodiment of the present disclosure.

Referring to FIG. 6, a wafer region according to an embodiment includes three identified regions Z1, Z3, and Z4. For example, the outer region includes a third region Z3 and a fourth region Z4. The reliability of the memory devices located in the first region Z1 is the highest, and the reliability of the memory devices located in the fourth region Z4 is the lowest. The reliability of the memory devices located in the third region Z3 is lower than the reliability of the memory devices in the first region Z1 and higher than the reliability of the memory devices in the fourth region Z4.

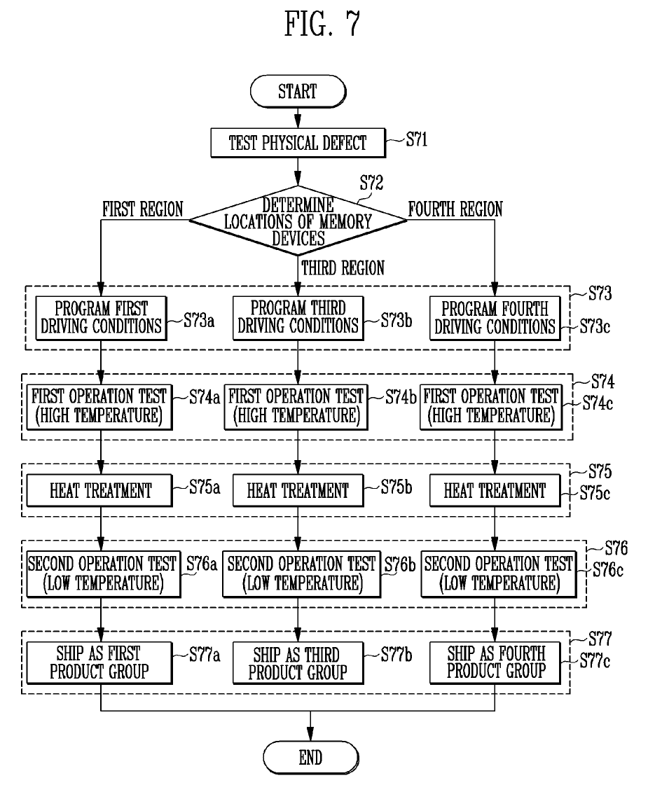

FIG. 7 is a flowchart illustrating a method of testing a memory device according to an embodiment of the present disclosure. The processes of the flowchart may be performed in a different order and may include fewer or additional processes than described and shown in FIG. 7. The flowchart of FIG. 7 may be performed by equipment that manufactures the memory device or separate test equipment configured to evaluate/program memory devices for various properties such as physical defects and performance characteristics.

Referring to FIG. 7, after the manufacturing processes for the memory devices are completed, a physical defect test is performed S71 on memory devices formed on the same wafer. Physical defects within a memory device include elements that contact each other but should be spaced apart or elements that should be in contact or extended but are spaced apart. Because physical defects significantly impact the reliability of memory devices, memory devices with a fail result from the physical defect test are classified separately from memory devices that pass the physical defect test. The memory devices classified as failed are difficult to use as memory devices and may be discarded.

Upon completion of the physical defect test S71, the locations are determined S72 for the memory devices that passed the physical defect test S71. For example, as described with reference to FIG. 6, the memory devices located in the first region Z1 of the wafer, the memory devices located in the third region Z3 of the wafer, and the memory devices located in the fourth region Z4 of the wafer are distinguished S72 from each other. In an embodiment, the memory devices located in the first region Z1 have higher reliability than the memory devices located in the third region Z3, and the memory devices located in the third region Z3 have higher reliability than the memory devices located in the fourth region Z4.

After the locations of the memory devices are determined S72, driving conditions for each memory device are programmed S73 based on the positions. The driving conditions may include unique information for a memory device and various values that enable normal operations, such as program operations, read operations, and erase operations, to be performed on the memory device. The driving conditions are programmed into the extra block E_BLK in FIG. 3 included in each memory device. First driving conditions are programmed S73a into the memory devices located in the first region, third driving conditions different from the first driving conditions are programmed S73b into the memory devices located in the third region, and fourth driving conditions different from the third driving operations are programmed S73c into memory devices located in the fourth region. For example, the first driving conditions correspond to values for product groups utilizing higher reliability than the third driving conditions, and the third driving conditions correspond to values for product groups utilizing higher reliability than the fourth driving conditions. The product group may be a type of electronic device in which a memory device is included. The first driving conditions may be programmed S73a at the same time the second driving conditions are programmed S73b and at the same time the third driving conditions are programmed S73c.

Upon completion of the programming S73, a first operation test is performed S74 to determine whether normal operations performed in the memory devices may be performed correctly at a higher temperature than a reference temperature. In an embodiment, during the first operation test S74, a test program operation, a test read operation, and a test erase operation are performed. For example, the test program operation may be performed by programming test data into the memory device and measuring the time taken for the test program operation. For example, the test read operation may be performed by measuring the time taken to read the test data programmed during the test program operation. For example, the test erase operation may be performed by measuring the time utilized to erase the memory block into which the test data is programmed. In addition to the time utilized to perform the test program operation, the test read operation, and the test erase operation, various other parameters may be tested during the first operation test S74. The pass criteria for the first operation test S74 may differ depending on the locations of the memory devices. For example, when the pass criterion for the first operation test performed S74a on the memory devices located in the first region is a first time, the pass criterion for the first operation test performed S74b on the memory devices located in the third region is a fifth time that is slower than the first time. The pass criterion for the first operation test performed S74c on the memory devices located in the fourth region is a sixth time slower than the fifth time.

Upon completion of the first operation test S74, heat treatment is performed S75 on the wafer. The heat treatment may be performed S75a, S75b, S75c at a temperature between 100 °C and 200 °C for durations between 30 minutes and 90 minutes, although the heat treatment conditions are not limited to these examples.

Upon completion of heat treatment S75, a second operation test is performed S76 to determine whether normal operations performed in the memory devices may be performed correctly at a lower temperature than the reference temperature. The second operation test may be performed S76 in the same manner as the first operation test S73. For example, during the second operation test S76, a test program operation, a test read operation, and a test erase operation are performed. For example, the test program operation may be performed by programming test data into the memory device and measuring the time taken for the test program operation. For example, the test read operation may be performed by measuring the time taken to read the test data programmed during the test program operation. For example, the test erase operation may be performed by measuring the time taken to erase the memory block into which the test data is programmed. In addition to the time taken for the test program operation, the test read operation, and the test erase operation, various other parameters may be tested during the second operation test S76. The pass criteria for the second operation test S76 may differ depending on the locations of the memory devices. For example, when the pass criterion for the second operation test performed S76a on the memory devices located in the first region is a third time, the pass criterion for the second operation test performed S76b on the memory devices located in the third region is a seventh time that is slower than the third time. The pass criterion for the second operation test performed S76b on the memory devices located in the fourth region is an eighth time that is slower than the seventh time.

After completion of the second operation test S76, memory devices that passed all tests ship S77 as a product group corresponding to the respective performance levels. For example, the memory devices located in the first region that passed all tests S71, S74a, and S76a ship S77a as a first product group. The memory devices located in the third region that passed all tests S71, S74b, and S76b ship S77b as a third product group. The memory devices located in the fourth region that passed all tests S71, S74c, and S76c ship S77c as a fourth product group. The first product group may be a group of electronic devices utilizing the highest reliability among the first, third, and fourth product groups, the fourth product group may be a group of electronic devices utilizing the lowest reliability among the first, third, and fourth product groups.

As described, by inputting different driving conditions to memory devices that have different reliability levels depending on a region of a wafer, and by simultaneously testing the memory devices with the different reliability levels under different conditions and shipping the memory devices, yield may be increased and the test time for the memory devices may be reduced.

According to an embodiment of the present disclosure, by simultaneously testing memory devices with different reliability levels and shipping the memory devices, the test time for the memory devices may be shortened and yield may be increased.

Concepts are disclosed in conjunction with examples and embodiments. Those skilled in the art will understand that various modifications, additions, combinations, and substitutions are possible without departing from the scope and technical concepts of the present disclosure. The embodiments disclosed in the present specification should be considered from an illustrative standpoint and not a restrictive standpoint. Therefore, the scope of the present disclosure is not limited to these descriptions. All changes within the meaning and range of equivalency of the claims are included within their scope.

What is claimed is:

1. A method of testing a memory device, the method comprising:
testing for a physical defect of memory devices formed on a wafer;
determining a region of the wafer where the memory devices are located when a test result for the physical defect is pass;
inputting first operation conditions to memory devices located in a first region and inputting second operation conditions to memory devices located in a second region; and
simultaneously testing the memory devices input with the first operation conditions and the memory devices input with the second conditions under various conditions.

2. The method of claim 1, further comprising shipping the memory devices tested simultaneously under the different conditions and located in a first region as a first product and shipping the memory devices tested simultaneously under the different conditions and located in a second region as a second product.

3. The method of claim 1, further comprising identifying a plurality of regions for the wafer based on a distance from a center of the wafer.

4. The method of claim 1, wherein each of the first operation conditions and the second operating conditions comprise program operation conditions, read operation conditions, and erase operation conditions.

5. The method of claim 4, wherein the program operation conditions comprise a program voltage, a pass voltage, a step voltage, and a program operation time.

6. The method of claim 4, wherein the read operation conditions comprise a read voltage, a pass voltage, and a read operation time.

7. The method of claim 4, wherein the erase operation conditions comprise an erase voltage, a pass voltage, and an erase operation time.

8. The method of claim 1, wherein the inputting the first operation conditions and the first operation conditions to the memory devices comprises classifying the memory devices as higher reliability when the memory devices are located closer to a center point of the wafer, and as lower reliability when the memory devices are located farther from the center point.

9. The method of claim 1, wherein simultaneously testing the memory devices comprises:
testing program operations, read operations, and erase operations performed on the memory devices at a higher temperature than a reference voltage;
heat treating the memory devices; and
testing the program operations, the read operations, and the erase operations performed on the memory devices at a lower temperature than the reference voltage.

10. The method of claim 1, wherein the memory devices are classified as devices having higher reliability for the memory devices located closer to a center point of the wafer, and are classified as devices having lower reliability for the memory devices located farther from the center point.

11. The method of claim 1, wherein the memory devices closer to a center point of the wafer are shipped as devices for high-specification products with higher performance, and the memory devices located farther from a center point of the wafer are shipped as devices for low-specification products with lower performance.

12. A method of testing a memory device, the method comprising:
manufacturing a plurality of memory devices on a wafer;
identifying a set of the plurality of memory devices as first memory devices located within a first distance from a center point of the wafer and a set of the plurality of memory devices as second memory devices located between the first distance and a second distance farther than the first distance from the center point;
inputting first driving conditions for program operations, read operations, and erase operations into the first memory devices and inputting second driving conditions corresponding to lower reliability than the first driving conditions into the second memory devices; and
simultaneously testing the first memory devices and the second memory devices under various conditions.

13. The method of claim 12, further comprising shipping memory devices passing a test among the first memory devices as a first product group, and shipping memory devices passing the test among the second memory devices as a second product group having lower reliability than the first product group.

14. The method of claim 12, wherein the first driving conditions and the second driving conditions comprise unique information for each of the first memory devices and the second memory devices and inputting values enabling normal operations in the first memory device and the second memory device.

15. The method of claim 14, wherein the unique information comprises storage capacity information, normal operation condition information, and manufacturing date information for each of the first memory devices and the second memory devices.

16. The method of claim 12, wherein the first driving conditions and the second driving conditions are input to extra blocks included in the first memory devices and second memory devices, respectively.

17. The method of claim 12, wherein during simultaneously testing the first memory devices and the second memory devices under the various conditions, a test program operation, a test read operation, and a test erase operation are performed.

18. The method of claim 12, wherein the first product group is a group of electronic devices utilizing higher reliability memory devices than the second product group.
